(19) United States
(12) Patent Application Publication
(10) Pub. No.: US 2014/0140176 A1
(43) Pub. Date: May 22, 2014

(54) LOCAL POSITIONING SYSTEM FOR REFRACTORY LINING MEASURING

(71) Applicant: SPECIALTY MINERALS (MICHIGAN) INC., Bingham Farms, MI (US)

(72) Inventors: Dietmar Dresen, Roetgen (DE); Christoph Carlhoff, Willich (DE); Rolf Lamm, Aachen (DE)

(73) Assignee: Specialty Minerals (Michigan) Inc., Bingham Farms, MI (US)

(21) Appl. No.: 13/680,340

(22) Filed: Nov. 19, 2012

(51) Int. Cl. G01B 11/24; G01B 17/06

(52) U.S. Cl. CPC G01B 11/24; G01B 17/06
USPC 367/99; 356/601

(57) ABSTRACT

A method and system for measuring wear in the lining of a vessel in which undirected radiation signals are transmitted by at least two transmitters at known positions to a receiver at the device for measuring wear. The distances between the transmitters and receiver are determined based on the time of flight of the radiation between the transmitters and receiver. The location of the receiver at the measuring device is determined to be at a point on an arc of points at the distance calculated based on the time of flight of the signal from each of the transmitters to the receiver. The receiver is determined to be at the intersection of the two arcs of points at the distance calculated based on the time of flight of the signal from the each of the transmitters. Also, the orientation of the measuring device relative to the known positions of the transmitters can be determined if a second receiver is present at or near the measuring device and receives signals from the transmitters based on the positions of the receivers relative to each other at the measuring device.

### BACKGROUND

The invention relates to a method for positioning a device for measuring wear in the lining of a metallurgical vessel, for example, a ladle or a basic oxygen furnace. The invention also relates to a system for determining the position of a device for measuring wear in the lining of a metallurgical vessel.

It is extremely important to measure wear in the lining of ladles or basic oxygen furnaces or other industrial containers which are used for example in the steel making process. This renders it possible to optimize the service life of the container and to prevent excessive wear in the lining from causing risks pertaining to production or industrial safety. As an example, wear linings of basic oxygen furnaces must be renewed relatively often, as their life time varies, depending on what is melted in the basic oxygen furnace, on the material of which the lining is made, and naturally on the number of melts for which the basic oxygen furnace is used.

The wear in a lining is measured by a method based on measuring the time of flight or the phase shift of a laser beam. The laser beam is directed to the lining on the inner surface of the basic oxygen furnace, from which it is reflected back to the measuring device. In the method based on measuring the time of flight, the distance between the measuring device and each measured point on the lining to be measured in the coordinate system of the measuring device can be calculated on the basis of the time difference between the emitting time and the return time of the laser beam. The measured points define the wear profile of the lining, which may be output for instance to a display terminal, by which the wear profile measured from a basic oxygen furnace in process can be compared graphically and numerically with the profile that was measured on the safety lining of the container or the working lining before the container was actually brought into use, i.e. before the first melt.

To measure wear in the lining of three-dimensional objects, such as basic oxygen furnaces, ladles and other containers used in industrial applications, by non-contacting methods, such as laser measurement, requires that the measuring device and the object to be measured are represented in the same coordinate system. Combining the coordinate systems of the measuring device and the object to be measured is called fixing. In other words, the measuring device is positioned or fixed in relation to the object. For fixing it is necessary to use three or more permanent marks, with the laser beam of the measuring device being directed sequentially towards each permanent mark, and the coordinates of each permanent mark are measured in the coordinate system of the measuring device. Even if the measuring device has a fixed position in the vicinity of the container through permanent marks, it is advisable to perform fixing for each lining measurement again, which ensures a change in the ambient conditions and other factors not to cause any errors.

In the so-called direct method normally used for positioning or fixing, stationary fixing points, also called permanent marks, are part of the object to be measured, or can be mounted to an object, or in the vicinity of the object. By means of the permanent marks the coordinate systems of the object and the measuring device can be mathematically combined. In the direct method, the object to be measured and the measuring device can be included into the same coordinate system by measuring at the same time both the permanent marks and the points to be actually measured.

In a special case where the object to be measured is supported by a tilt axis, indirect angle measurement fixing can be applied, with the permanent marks being located on the container or outside of the container. An angle measuring device can be mounted, for example, to the tilt axis of the container or can be mounted elsewhere to the container. An example of such measuring device is a so-called inclinometer or tilt sensor. At present, fixing by means of angle measurement is an indirect method which is used when it is difficult to provide the object to be measured with necessary fixing points which are clearly visible and which position can not be recognized otherwise. Angle measurement fixings have been performed using fixing points on the container or on structures outside the object to be measured and using an angle value obtained from the angle measurement device, whereby the coordinate systems could be mathematically combined. The permanent marks are attached to the container or to the frame structures of a factory wall, for example, in vicinity to the basic oxygen furnace. When angle measurements were used in the known methods, the angle measurement device informs the measuring device of the position of the object or container in relationship to the known surroundings.

In both direct and indirect angle measurement fixing methods, the permanent marks can be, for example, small plates, cylinders, spheres or other regularly shaped objects made from a material which reflects laser radiation. In these known methods, the object is to direct the laser beam manually towards the center of the permanent marks in order to obtain a fixing point. The operators of the measuring device are thus required to perform several operations before all fixing points have been measured. The drawback of these known methods is seen in the fact that it is difficult to automate the fixing operation. When fixing is carried out by a person, there is a risk of errors in both the estimate of the center of the fixing points or permanent marks as well as in the actual aligning step.

U.S. Pat. No. 6,922,251 to Kirchhoff et al. which is hereby incorporated by reference discloses a method for measuring the refractory lining of a metallurgical container by means of a laser scanner wherein the laser scanner is positioned centrally in front of the container in preparation of the measuring step to establish a precise definition of the position of the laser scanner relative to the container with the aid of permanent marks attached to the said container. Once the container has been emptied, measuring of the interior of the container can be performed in that a laser beam which can be deflected horizontally and vertically scans the inner surface of the container. The laser beams reflected from the refractory lining are received and are processed in accordance with their time of flight. Since also the position of the receiver is well known relative to the laser head and the respective angle position of the laser head has been determined for each individual laser beam, the shape of the surface of the refractory lining can be reconstructed from the data generated. Advantageously the container is not only scanned in its horizontally tilted position, but scanning is also done in two additional tilted positions, for example 20° upwards and approximately 20° downwards to possible scan the entire interior of the vessel.

After the central scan of the refractory lining, also a left and right scan can be performed in the method known from U.S. Pat. No. 6,922,251 to also scan the entire side wall near the opening of the vessel by moving the laser scanner into left or right positions with respect to the vessel. The laser scanner has to be moved because the vessel can be tilted about its horizontal axis only but not to the left or right. However, each time the laser scanner is moved, an additional position measurement of the laser scanner must be performed with the laser scanner when scanning from the left or right position prior to actual measuring scan. This requires additional time of several minutes and thus prolongs the interruption time of the production process.

Optical or other laser methods of determining the position of the vessel require a direct line of sight between the vessel and the measuring device. The radio waves used by the positioning and measurement devices of the present invention do not require a direct line of sight to an object to determine the position of the object. Also in some embodiments of the present invention the orientation of the object can be determined.

### SUMMARY

The present invention is directed to a method for determining the position and optionally, the orientation of a device for measuring wear in the lining of a metallurgical vessel, for example, a ladle or a basic oxygen furnace. The invention also relates to a system for determining the position and optionally, the orientation of a device for measuring wear in the lining of a metallurgical vessel.

The system or device for measuring the contour of a refractory lining of a vessel, e.g. a steel ladle, can be a laser scanner which comprises a laser head as part of the laser scanner for emitting laser beams which can be deflected in vertical and horizontal directions and a receiving means in the vicinity of the laser head for receiving the laser beams reflected from the refractory lining to determine their directions and their time of flight.

An embodiment of the invention is a system and method for determining the position of a device for measuring wear in the lining of a metallurgical vessel wherein the system includes two transmitters on a wall, walls or structure in the vicinity of the metallurgical vessel and a receiver for receiving a signal or signals from each of the transmitters on or near the measuring device. The transmitters can be secured to the walls of the building or to the floor of the building or a structure or structures in the building. After the transmitters are fixed in a position which does not change, the location of the transmitters in a coordinate system can be determined such as by scanning by a laser beam so that a precise position of the marks can be determined by the laser scanner. If the location of the transmitters are fixed and their position is known in a coordinate system then it is not necessary to determine the position of the transmitters each time it is desired to determine the position of the measuring device. The location of the measuring device can be determined in the coordinate system of the transmitters.

A receiver for receiving a signal from each of the two transmitters is placed at a position on or near the device for measuring wear of the lining of a metallurgical vessel such that the position of the receiver in the coordinate system of the measuring device is known.

The first transmitter transmits a signal to the receiver. Based on the time of flight of the radio signal from the first transmitter to the receiver the distance from the receiver to the first transmitter is determined.

The second transmitter transmits a signal to the receiver. Based on the time of flight of the radio signal at the speed of electromagnetic radiation from the second transmitter to the receiver the distance from the receiver to the second transmitter is determined.

Each of the two transmitters can send out a signal that identifies which transmitter is transmitting a signal.

Because the two distances from each transmitter defines possible locations of the receiver which all lie along a circle, the location of the receiver is obtained by determining the location of the intersection of the two circles around each of the transmitters.

The circles which are defined by the possible locations of the receiver at a specified distance from the transmitter can intersect at two locations. However, oftentimes one possible solution or intersection of the circles is not logical and even may be very distant from the actual location of the device for measuring wear of a vessel. When the circles intersect at two locations and one location is not logical or possible then the receiver is located at the other intersection of the circles.

An embodiment of the invention is a system and method for determining the position and orientation of a device for measuring wear in the lining of a metallurgical vessel wherein the system includes two transmitters on a wall, walls or structure in the vicinity of the metallurgical vessel and two receivers for receiving a signal or signals from each of the transmitters. After the transmitters are fixed in a position which does not change, the location of the transmitters in a coordinate system can be determined such as by scanning by a laser beam so that a precise position of the marks can be determined by the laser scanner.

The receivers for receiving a signal from each of the two transmitters are placed at a position on or near the device for measuring wear of the lining of a metallurgical vessel such that the position of the receiver in the coordinate system of the measuring device is known. In order for the orientation of the measuring device in the coordinate system of the transmitters to be determined the location of the receivers relative to the measuring device should be known.

The transmitters transmit a signal to each of the receivers. Based on the time of flight of the radio signal at the speed of electromagnetic radiation from the transmitters to the receivers the distance from the receiver to the second transmitter is determined.

Each of the two transmitters can send out a signal that identifies which transmitter is transmitting a signal.

The location and orientation of the measuring device can be determined based on the circles or arc defined by the possible locations of the receivers at a specified distance from the transmitter can intersect at two locations.

In some embodiments two receivers can be located on the walls or structures in the vicinity of the measuring device and a transmitter can be located near the measuring device to determine the location of the measuring device.

In some embodiments two receivers can be located on the walls or structures in the vicinity of the measuring device and two transmitters can be located near the measuring device to determine the location and orientation of the measuring device.

In some embodiments two transmitters can be located on the same wall in the vicinity of the measuring device and two receivers can be located near the measuring device to determine the location and orientation of the measuring device.

In some embodiments two transmitters can be on opposite walls on both sides of the measuring device and two receivers can be located near the measuring device to determine the location and orientation of the measuring device. In order to provide that there is only one point of intersection of the circles located at a constant radius from the transmitters, the transmitters and receivers are arranged along a straight line.

In some embodiments two receivers can be on opposite walls on both sides of the measuring device and two transmitters can be located near the measuring device to determine the location and orientation of the measuring device. In order to provide that there is only one point of intersection of the circles located at a constant radius from the receivers, the transmitters and receivers are arranged along a straight line.

In some embodiments, two transponders can be located on walls or structures in the vicinity of the measuring device and two transceivers can be located near the measuring device to determine the location and orientation of the measuring device.

The transponders can receive a signal from the transceivers and then the transponders can transmit a signal back to the transceivers to determine the position and orientation of the measuring device.

In some embodiments, two transponders can be located on walls or structures in the vicinity of the measuring device and a transceiver can be located near the measuring device to determine the location of the measuring device. The transponders can receive a signal from the transceiver and then the transponders can transmit a signal back to the transceiver to determine the position of the measuring device.

In some embodiments three receivers can be located on walls or structures in the vicinity of the measuring device and three transmitters can be located near the measuring device to determine the location and orientation of the measuring device.

In some embodiments three transmitters can be located on walls or structures in the vicinity of the measuring device and three receivers can be located near the measuring device to determine the location and orientation of the measuring device.

In some embodiments, three transponders can be located on walls or structures in the vicinity of the measuring device and three transceivers can be located near the measuring device to determine the location and orientation of the measuring device. The transponders can receive a signal from the transceiver and then the transponders can transmit a signal back to the transceiver to determine the position of the measuring device.

In some embodiments, two transceivers can be located on walls or structures in the vicinity of the measuring device and two transmitters can be located near the measuring device to determine the location and orientation of the measuring device. The transponders can receive a signal from the transceiver and then the transponders can transmit a signal back to the transceiver. The determination of the position and orientation of the measuring device can occur at a location away from the measuring device.

In some embodiments three transmitters can be located on walls or structures in the vicinity of the measuring device and two receivers can be located near the measuring device to determine the location and orientation of the measuring device.

In some embodiments three receivers can be located on walls or structures in the vicinity of the measuring device and two transmitters can be located near the measuring device to determine the location and orientation of the measuring device.

### BRIEF DESCRIPTION OF THE DRAWINGS

The invention will now be described in connection with the drawings, in which:

FIG. 1 shows a plan view of an embodiment of a local positioning system of the present invention for measuring wear in a refractory lining showing two transmitters on perpendicular walls and a base station on a mobile laser scanner having a receiver;

FIG. 2 shows a plan view of another embodiment of the present invention showing two transmitters on perpendicular walls and a base station on a mobile laser scanner having two receivers;

FIG. 3 shows a plan view of another embodiment of a local positioning system of the present invention showing two receivers on perpendicular walls and a base station on a mobile laser scanner having a transmitter;

FIG. 4 shows a plan view of another embodiment of the local positioning system of the present invention showing two receivers on perpendicular walls and a base station on a mobile laser scanner having two transmitters;

FIG. 5 shows a plan view of another embodiment of a local positioning system of the present invention showing two transmitters on a wall and a base station on a mobile laser scanner having a receiver;

FIG. 6 shows a plan view of another embodiment of a local positioning system of the present invention showing two transmitters on a wall and a base station on a mobile laser scanner having two receivers;

FIG. 7 shows a plan view of a local positioning system showing two transmitters on opposite walls and a base station on a mobile laser scanner having two receivers mounted diagonally from each other on the laser scanner;

FIG. 8 shows a plan view of another embodiment of a local positioning system of the present invention showing two transmitters on opposite walls and a base station on a mobile laser scanner having two receivers;

FIG. 9 shows a plan view of another embodiment of a local positioning system of the present invention showing two transponders and a base station on a mobile laser scanner having two transceivers;

FIG. 10 shows a side view of another embodiment of a local positioning system of the present invention showing two transponders and a base station on a mobile laser scanner having a transceiver;

FIG. 11 shows a plan view of another embodiment of a local positioning system of the present invention showing three receivers and a base station on a mobile laser scanner having three transmitters;

FIG. 12 shows a plan view of another embodiment of a local positioning system of the present invention showing three transmitters and a base station on a mobile laser scanner having three receivers;

FIG. 13 shows a plan view of another embodiment of a local positioning system of the present invention showing three transponders and a base station on a mobile laser scanner having three transceivers;

FIG. 14 shows a plan view of another embodiment of a local positioning system of the present invention showing two transponders on a base station on a mobile laser scanner and two transceivers;

FIG. 15 shows a plan view of another embodiment of a local positioning system of the present invention showing three transmitters and a base station on a mobile laser scanner having two receivers; and

FIG. 16 shows a plan view of another embodiment of a local positioning system of the present invention showing three receivers and a base station on a mobile laser scanner having two transmitters.

### DETAILED DESCRIPTION OF THE PREFERRED EMBODIMENTS

It is to be noted that in all figures same parts are provided with the same reference numerals. It is emphasized that, according to common practice, the various dimensions of the component parts of the apparatus as shown in the drawings are not to scale and have been enlarged for clarity. Also, the directional designations “left” or “right” are not to be construed as limited to any specific orientation but, rather, are for reference purposes as they pertain to the views as shown in the drawing figures.

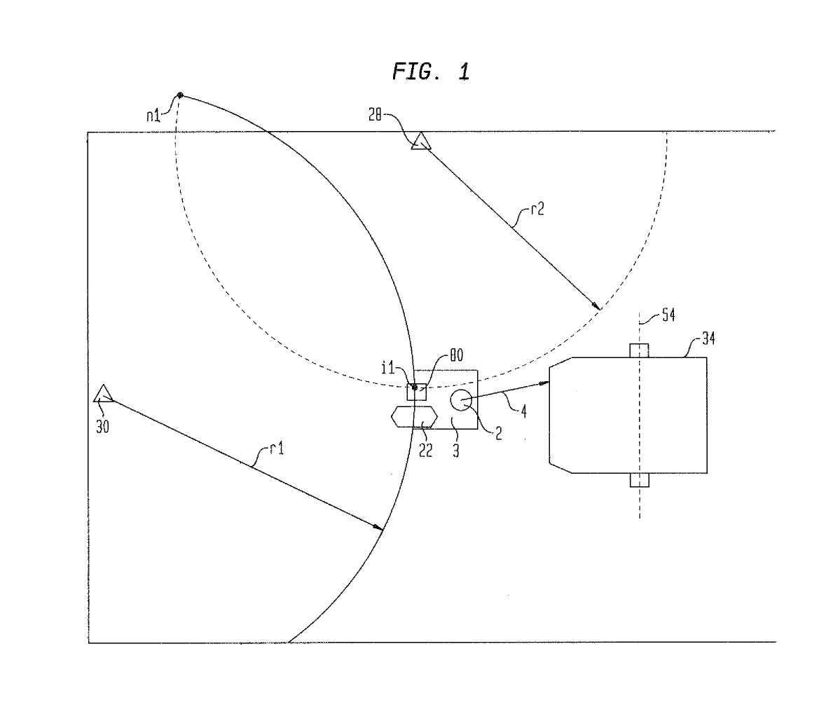

As seen in FIG. 1 is a system for determining the position of a device for measuring wear in the lining of a metallurgical vessel wherein the system includes two transmitters 28, 30 on a wall, walls or structure in the vicinity of the metallurgical vessel 34 and a receiver 80 for receiving a signal or signals from each of the transmitters 28, 30 on or near the measuring device 3 which can be a laser scanner having laser head 2. The transmitters can be secured to the walls of the building or to the floor of the building or a structure or structures in the building. After the transmitters are fixed in a position which does not change, the location of the transmitters in a coordinate system can be determined such as by scanning by a laser beam so that a precise position of the marks can be determined by the laser scanner. If the location of the transmitters 28, 30 are fixed and their position is known in a coordinate system then it is not necessary to determine the position of the transmitters 28, 30 each time it is desired to determine the position of the measuring device. The location of the measuring device 3 can be determined in the coordinate system of the transmitters 28, 30.

A receiver 80 for receiving a signal of undirected radiation from each of the two transmitters 28, 30 is placed at a position on or near the device 3 for measuring wear of the lining of a metallurgical vessel such that the position of the receiver 80 in the coordinate system of the measuring device is known.

The first transmitter 30 transmits a signal to the receiver 80. Based on the time of flight of the radio signal of electromagnetic radiation from the first transmitter 30 to the receiver 80 the distance r1 from the receiver to the first transmitter 30 is determined.

The second transmitter 28 transmits an undirected signal of electromagnetic radiation to the receiver 80. Based on the time of flight of the radio signal at the speed of electromagnetic radiation from the second transmitter 28 to the receiver 80 the distance r2 from the receiver 80 to the second transmitter 28 is determined.

Each of the two transmitters can send out a signal that identifies which transmitter is transmitting a signal.

Because the two distances from each transmitter defines possible locations of the receiver which all lie along a circle, the location of the receiver 80 at i1 is obtained by determining the location of the intersection of the two circles around each of the transmitters 28, 30.

The circles which are defined by the possible locations of the receiver at a specified distance from the transmitter can intersect at two locations. However, oftentimes one possible solution or intersection of the circles, here at n1 is not logical and even may be very distant from the actual location of the device 3 for measuring wear of a vessel. When the circles intersect at two locations and one location is not logical or possible then the receiver is located at the other intersection of the circles.

The time of flight of the undirected signal from the transmitters 28, 30 to receiver 80 can be short as in picoseconds. The distance between the transmitters 28, 30 and receiver 80 can be 25 to 35 meters, preferably 30 meters.

Base station 22 can calculate the location i1 of the receiver 80 on the measuring device by receiving the time of flight from the transmitters 28, 30 to receiver 80.

The measuring device can be a laser scanner, acoustic scanner, charge coupled device (CCD), radar or theodolite, optical measuring device.

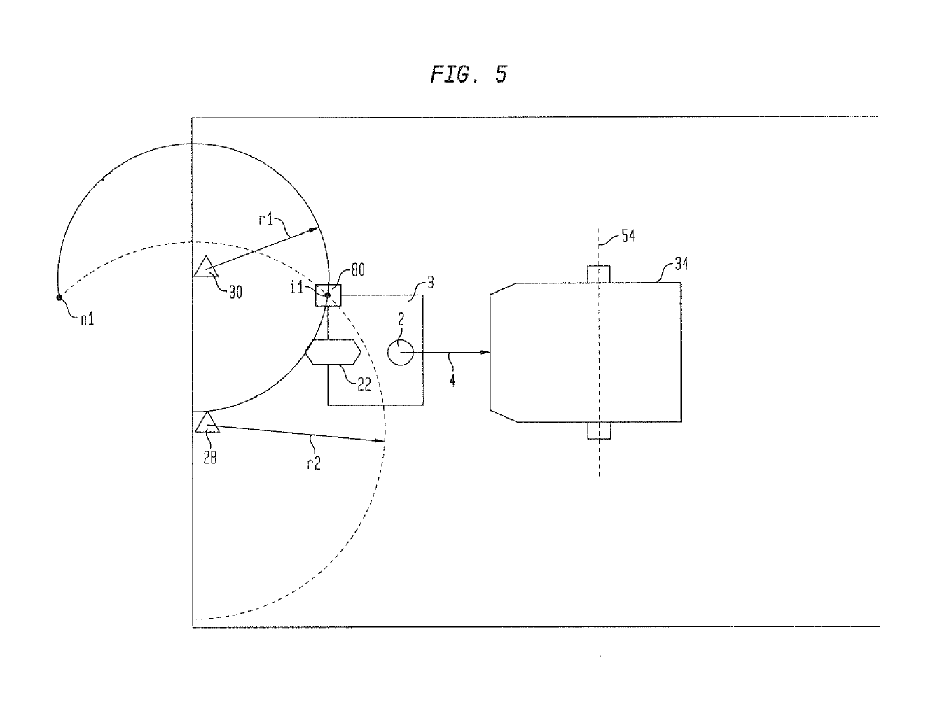

As seen in FIG. 5 the transmitters 28 and 30 can be on the same wall to determine the location i1 of the receiver 80 based on the distances r2 and r1 from transmitter 28 and 30 respectively.

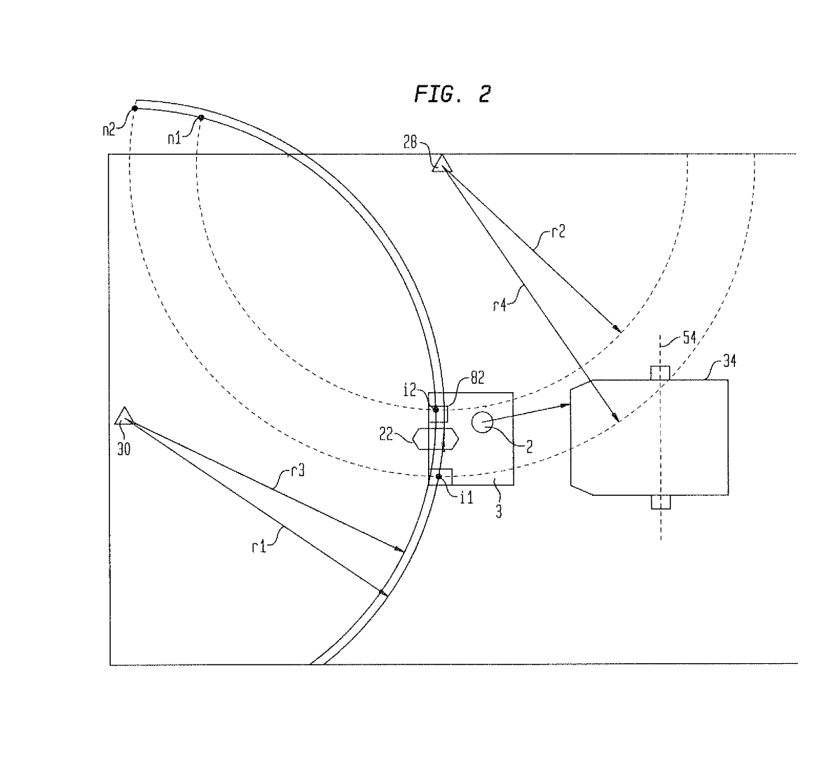

As seen in FIG. 2, the location it and i2 of the receivers 80 and 82 respectively can be determined. Location i1 can be determined as the location which is located at a distance r1 from transmitter 30 and also is located at a distance r2 from transmitter 28. Location i2 can be determined as the location which is located at a distance r3 from transmitter 30 and also is located at a distance r4 from transmitter 28. Because receivers 80 and 82 can be fixed, if the locations of receivers 80 and 82 is known on the scanner 3 then the orientation of the scanner in the coordinate system of transmitters 28 and 30 can be determined. Of course, locations n1 and n2 are not logical for the receiver and are therefore not possible.

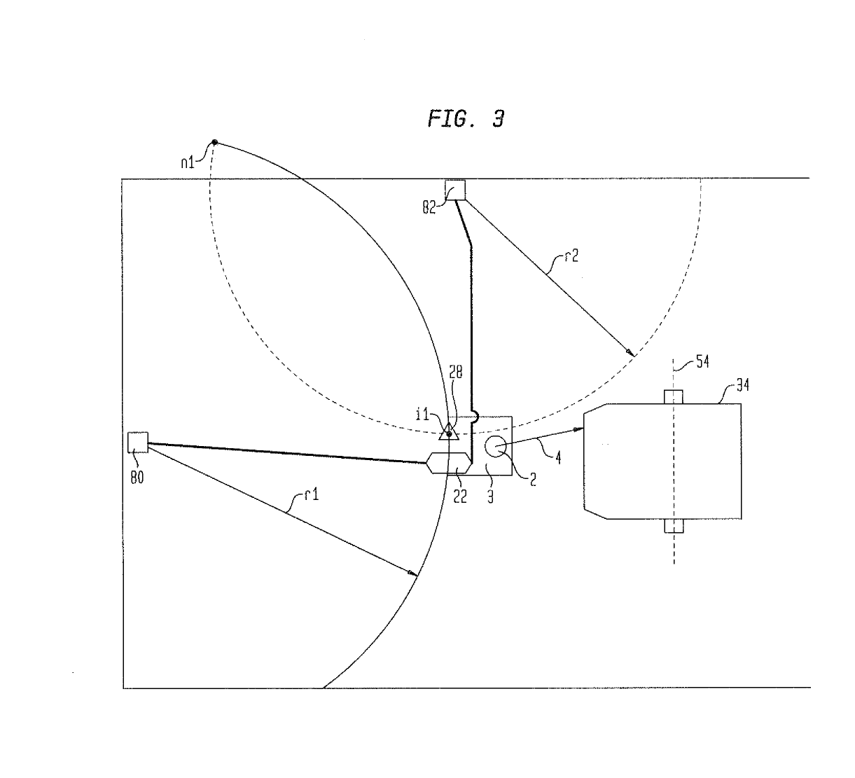

As seen in FIG. 3, if receivers 80 and 82 are located in the vicinity of the measuring device 3 on two walls in the measurement area of the measuring device or scanner 3, then transmitter 28 can be located on, at or near the measuring device 3 and can be determined by finding the location which is at a distance r1 from receiver 80 and at a distance r2 from receiver 82.

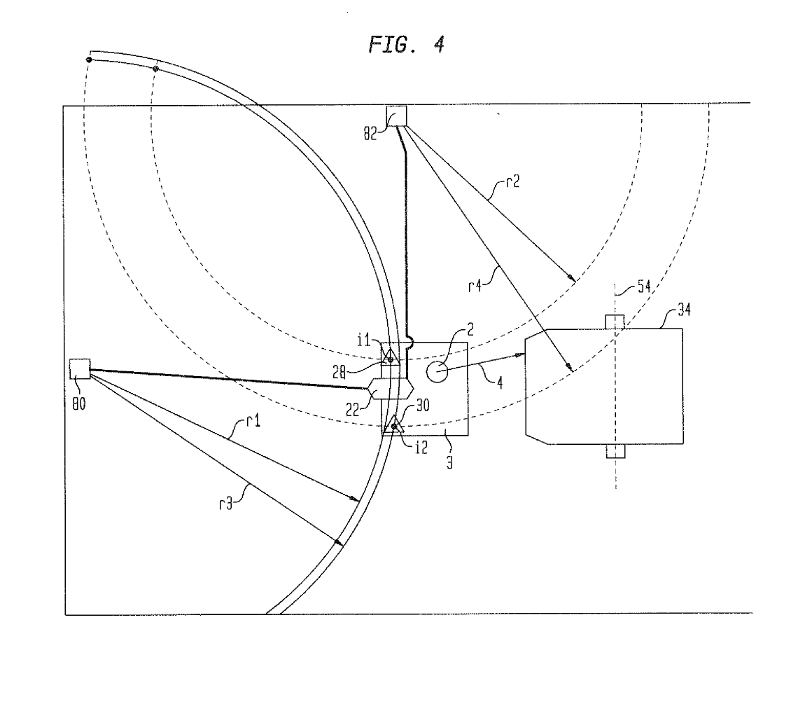

As seen in FIG. 4, if receivers 80 and 82 are located in the vicinity of the measuring device on two walls in the measurement area of the measuring device 3 or scanner then the locations of transmitters 28 and 30 can be located on, at or near the measuring device and their positions can be determined. Position i1 is the location which is at a distance r2 from receiver 82 and at a distance r1 from receiver 80. Position i2 is the location which is at a distance r3 from receiver 80 and at a distance r4 from receiver 82.

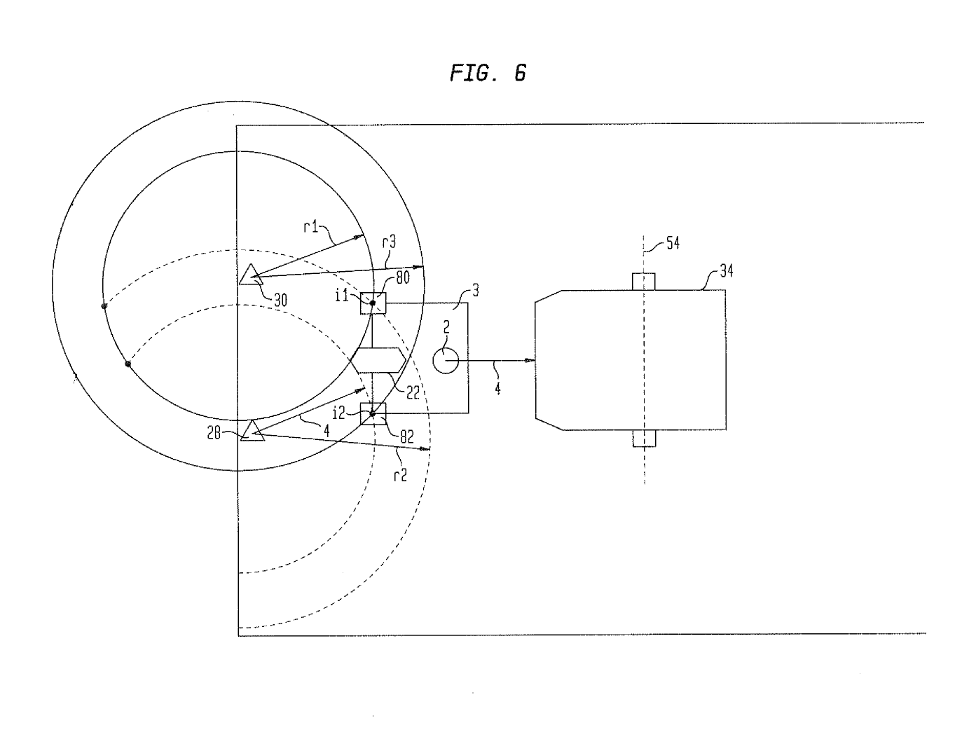

As seen in FIG. 6, transmitters 28 and 30 can be the same wall. Location i1 of receiver 80 is the location at a distance r1 from transmitter 30 and at a distance r2 from transmitter 28. Location 12 of receiver 82 is the location at a distance r3 from transmitter 30 and at a distance r4 from transmitter 28.

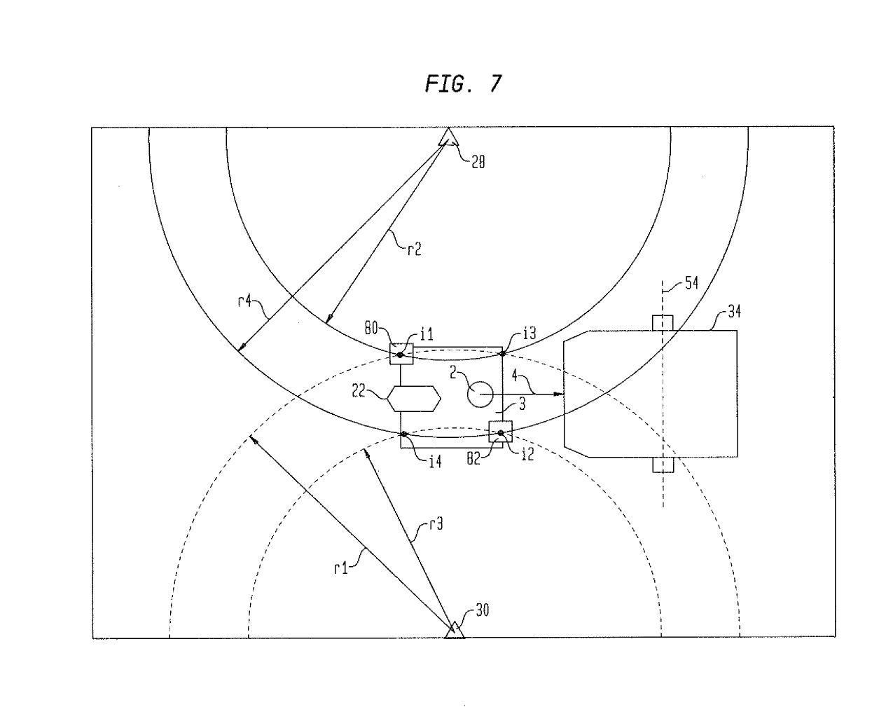

As can be seen in FIG. 7, if the locations of transmitters 28 and 30 and receivers 80 and 82 are not in a straight line then the determination of positions i1 and i2 for receivers 80 and 82 is difficult because there are two solutions for each of locations i1 and i2. There are two locations i1 and i3 at a distance r2 from transmitter 28 and at a distance r1 from transmitter 30. Similarly, there are two locations i2 and i4 at a distance r4 from transmitter 28 and at a distance r3 from transmitter 30.

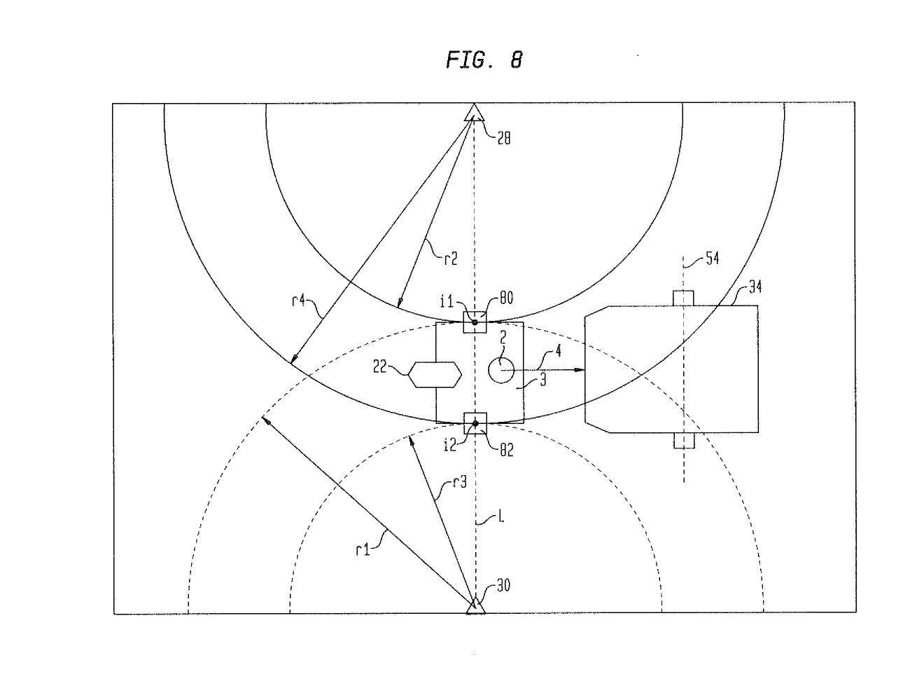

As seen in FIG. 8, if transmitter 28 and 30 and receivers 80 and 82 are substantially in a straight line L then the determination of positions i1 and i2 for receivers 80 and 82 is possible. Location i1 is at a distance r2 from transmitter 28 and at a distance r1 from transmitter 30. Location i2 is at a distance r4 from transmitter 28 and at a distance r3 from transmitter 30.

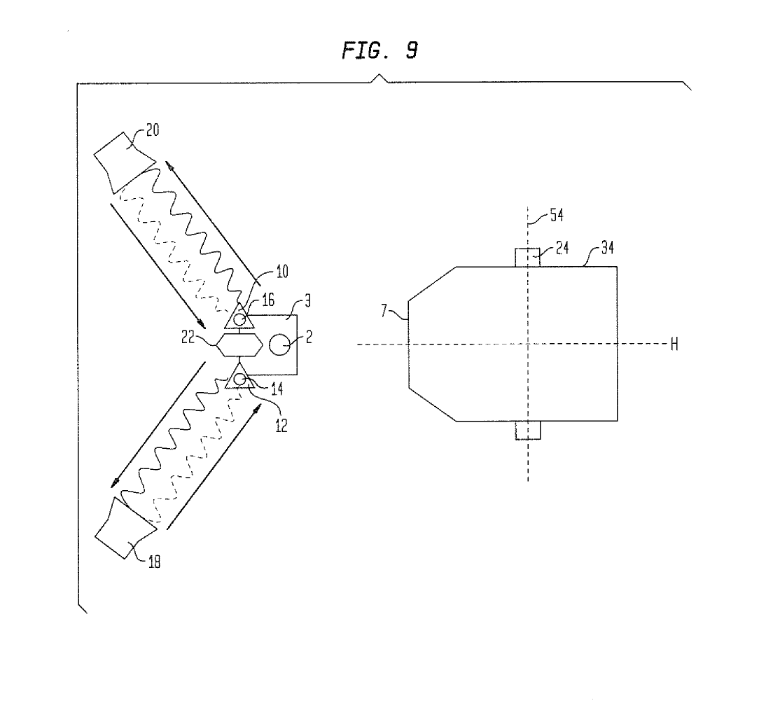

As seen in FIG. 9, transponders 18 and 20 which can be at known positions on the same wall or perpendicular walls or walls at an angle to each other emit a signal when the transponders 18 and 20 receive an undirected electromagnetic signal such as a radio signal from a transmitter or transceiver, here transceivers 12 and 10 which have antennae 14 and 16. The signal from transponder 20 can have a code which distinguishes that signal from the signal from transponder 18. Accordingly, the locations of transceivers 10 and 12 can be determined by measuring the time of flight of a signal from the transceiver to the transponder and back to the transceiver and determining the distance between each of transponder 20 and transponder 18 to transceiver 10 and between each of transponder 20 and transponder 18 to transceiver 12. Support means 26 can support transponders 18 and 20.

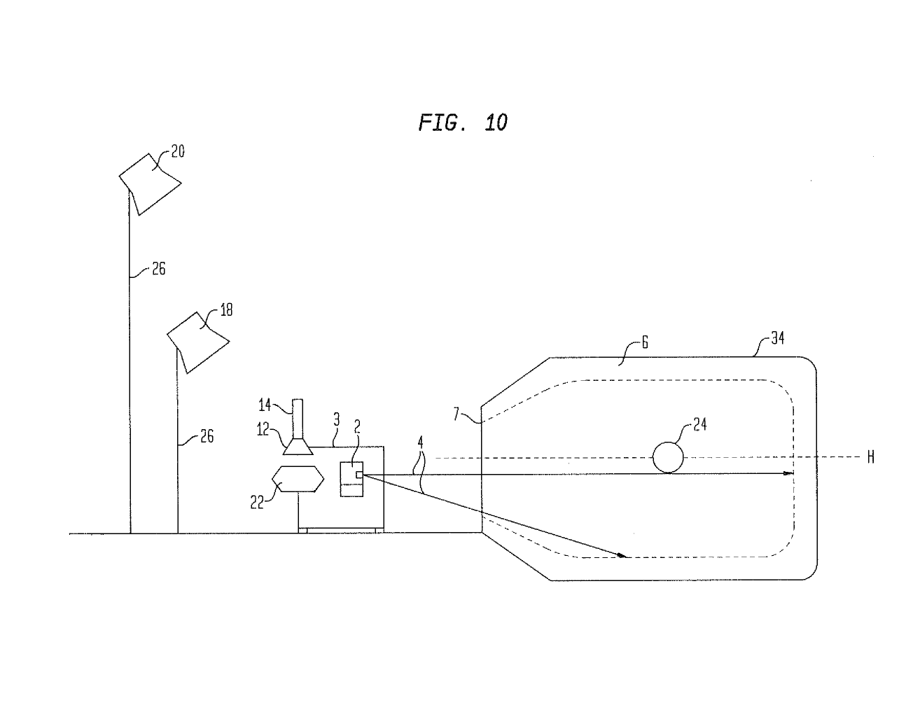

As seen in FIG. 10, the system for measuring wear in a refractory lining can be provided with a video display for showing the measured contour of the refractory lining 6 of vessel 34. An image of the contour of the refractory lining 6 can be transmitted to a remote video display (not shown). The system for measuring wear can be operated remotely by a high speed Ethernet link. The system for measuring wear in a refractory lining can be operated by a direct hardwired connection. A portion of connection between the operator or operators operating the system can be wireless. Base station 22 can calculate or determine the location of transceiver 12 based on the time of flight of signals from transponders 18 and 20 as described above.

Vessel 34 has opening 7 and can be tilted at trunnion 24 at axis 54 to provide the possibility of scanning lining 6 from different angles.

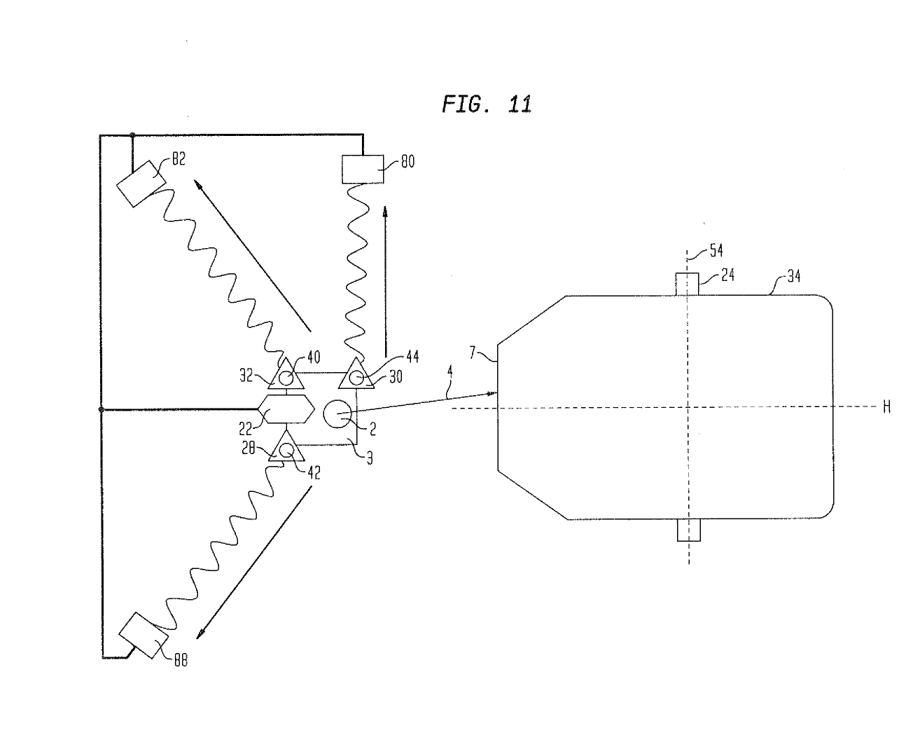

As seen in FIG. 11, three receivers 80, 82 and 88 can be located at known positions along the walls or structures of the room or area in the vicinity of the measuring device 3. Three transmitters 28, 30 and 32 can be located at or near the measuring device 3 to determine the location of the measuring device 3 based on the determination of the locations of the transmitters based on the time of flight of the undirected signal from the transmitters to the receivers 80, 82 and 88. Receivers 80, 82 and 88 can transmit data to base station 22 which determines the location of transmitters 28, 30 and 32. Transmitters 28, 30 and 32 can have antennae 42, 40 and 44 to transmit undirected signals to receivers 80, 82 and 88.

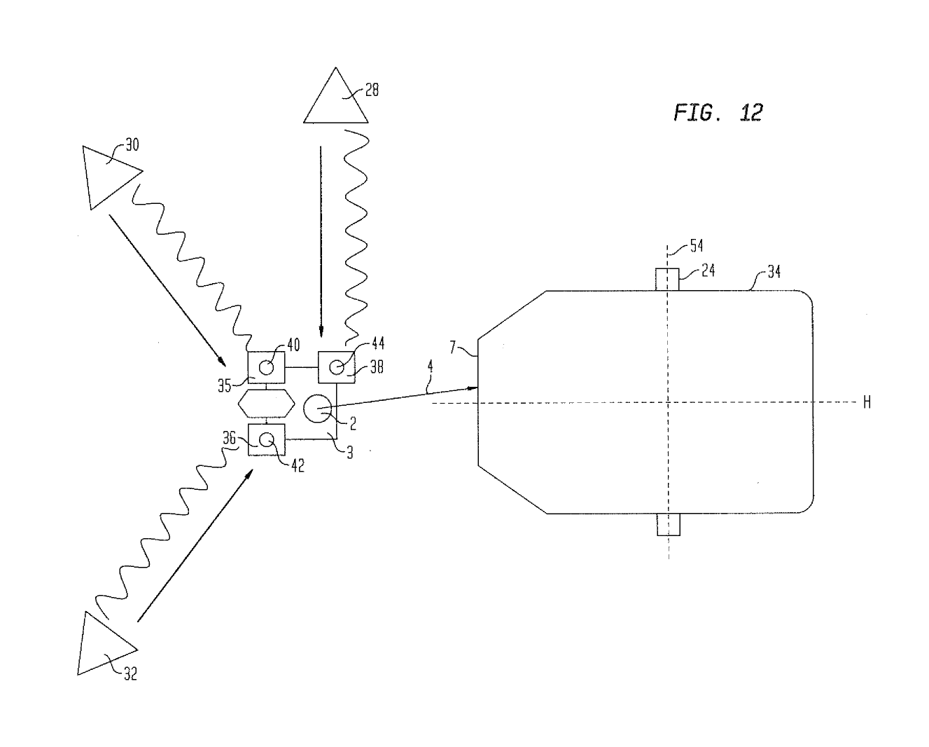

As seen in FIG. 12, three transmitters 28, 30 and 32 can be located at known positions along the walls or structures of the room or area in the vicinity of the measuring device 3. Three receivers 35, 36 and 38 can be located at or near the measuring device 3 to determine the location of the measuring device 3 based on the determination of the locations of the transmitters based on the time of flight of the undirected signal from the transmitters to the receivers 35, 36 and 38 which can transmit data to base station 22 which permits the determination of the location of receivers 35, 36 and 38. Receivers 35, 36 and 38 can have antennae 40, 42 and 44 to transmit undirected signals to receivers 35, 36 and 38.

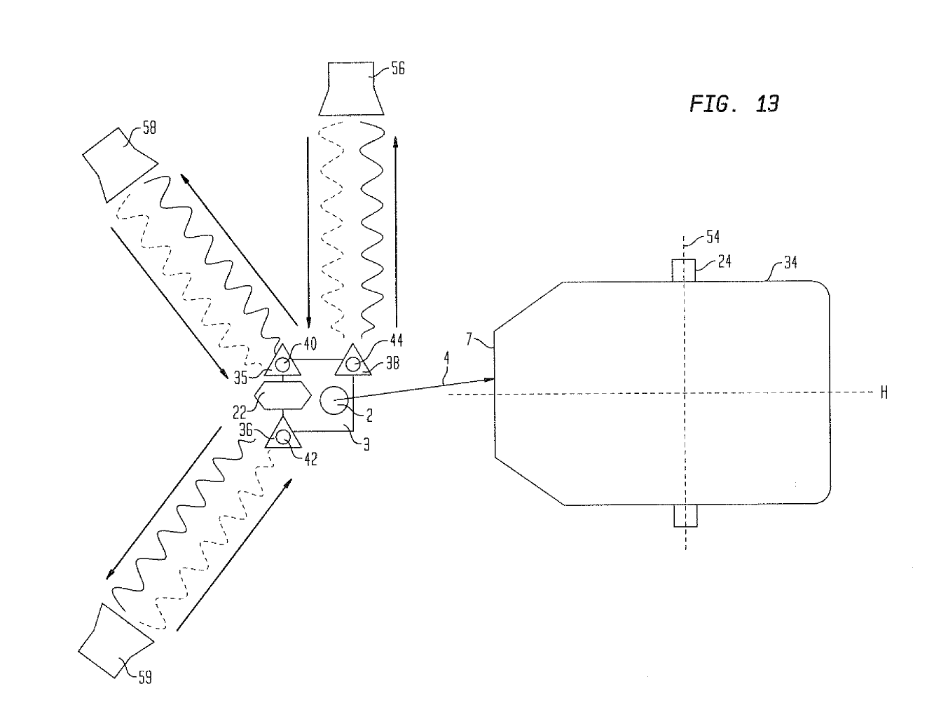

As seen in FIG. 13, transponders 56, 58 and 59 which can be at known positions on the same wall or perpendicular walls or walls at an angle to each other emit a signal when the transponders 56, 58 and 59 receive an undirected electromagnetic signal such as a radio signal from a transmitter or transceiver, here transceivers 35, 36 and 38 which have antennae 40, 42 and 44. Accordingly, the locations of transceivers 35, 36 and 38 can be determined by measuring the time of flight of a signal from a transceiver to a transponder and back to a transceiver and determining the distance between each of transponders 56, 58 and 59 to transceivers 35, 36 and 38.

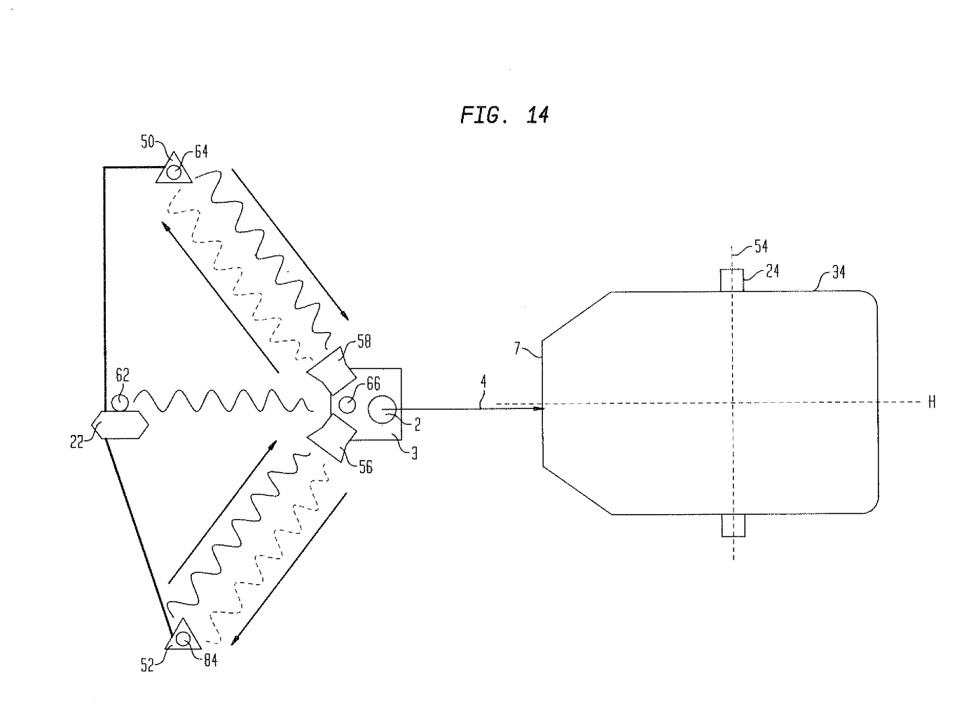

As seen in FIG. 14, transponders 56 and 58 which can be at, on or near the measuring device 3 emit a signal when the transponders 56 and 58 receive an undirected electromagnetic signal such as a radio signal from a transmitter or transceiver, here transceivers 50 and 52 which have antennae 64 and 84. Accordingly, the locations of transponders 56 and 58 can be determined by measuring the time of flight of a signal from the transceiver to the transponder and back to the transceiver and determining the distance between each of transponders 56 and 58 to transceivers 50 and 52.

In FIG. 14 it is shown that base station 22 can communicate or transmit here by antenna 62 to laser scanner 3 the locations of transponder 56 and 58.

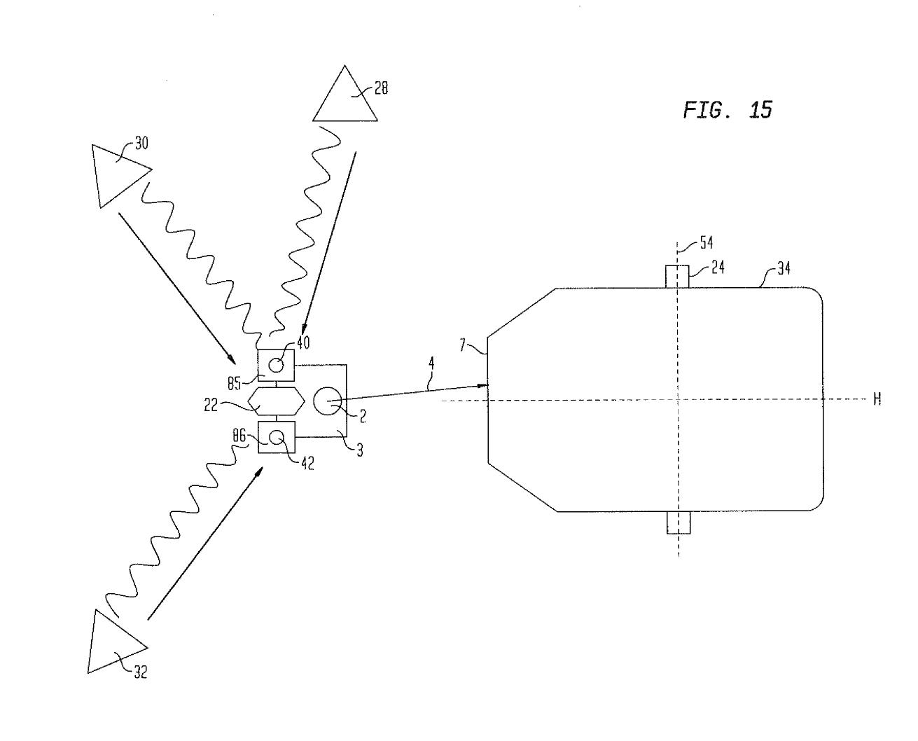

As seen in FIG. 15, three transmitters 28, 30 and 32 can be at known locations in the vicinity of the measuring device 3 and each transmit an undirected signal to two receivers 85 and 86 having antennae 40 and 42 respectively. Accordingly, the locations of receivers 85 and 86 can be determined by measuring the time of flight of a signal from the transmitter to the receivers 85 and 86 and determining the distance between each of transmitters 28, 30 and 32 to receivers 85 and 86. Also, the orientation of the measuring device or scanner 3 can be determined in the coordinate system of the transmitters 28, 30 and 32 if the location of the receivers 85 and 86 are known relative to the measuring device 3.

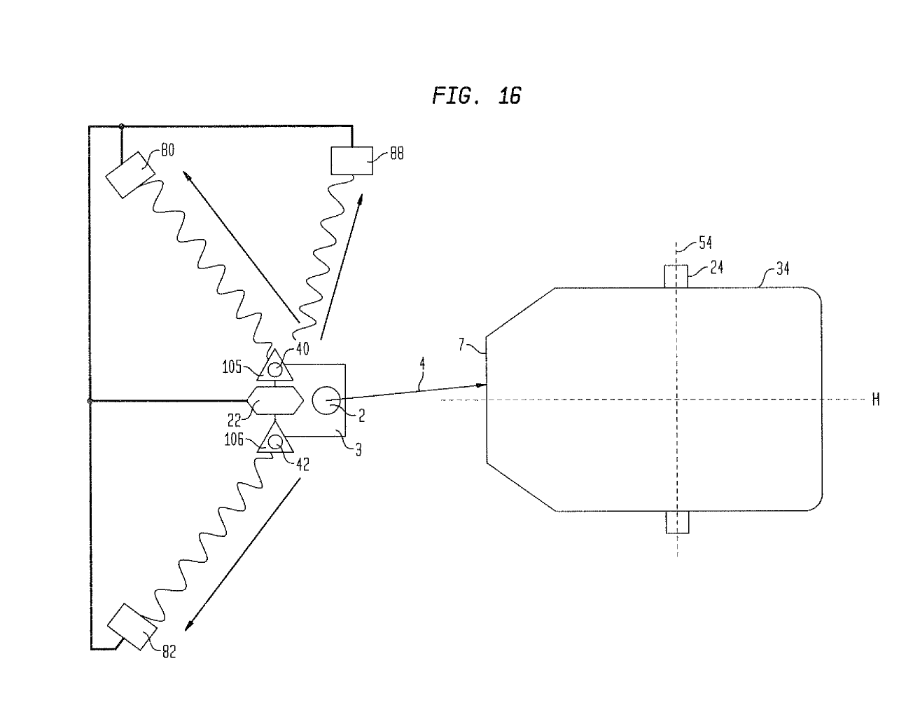

As seen in FIG. 16, three receivers 80, 82 and 88 can be at known locations in the vicinity of the measuring device and receive an undirected signal from two transmitters 105 and 106 having antennae 40 and 42 respectively. Accordingly, the locations of transmitters 105 and 106 can be determined by measuring the time of flight of a signal from the transmitters 105 and 106 to the receivers 80, 82 and 88. Also, the orientation of the measuring device or laser scanner 3 can be determined in the coordinate system of the receivers 80, 82 and 88 if the location of the transmitters 105 and 106 are known relative to the measuring device 3.

The vessel which is scanned can be a ladle, a basic oxygen furnace or other industrial lining measurement application.

The method as described in International PCT Publication WO2007064928 and its equivalent U.S. Pat. No. 7,924,438 which is incorporated by reference in its entirety can be carried out in some embodiments on the present invention.

Although the invention has been described above with reference to the examples according to the accompanying drawings, it will be obvious that the invention is not restricted thereto but can be modified in many ways within the scope of the inventive concept disclosed in the appended claims.

What is claimed is:

1. A method of measuring the refractory lining of a metallurgical vessel by means of a laser, optical, acoustic or electromagnetic radiation measuring device comprising the steps of:
transmitting a first signal in the form of undirected electromagnetic radiation from a first position in the vicinity of the measuring device;
transmitting a second signal in the form of undirected electromagnetic radiation from a second position in the vicinity of the measuring device;
receiving the first and second signals at a third position at or near the measuring device;
determining the distance between the first position and the third position (r1) and between the second position and the third position (r2) based on the time of flight of the electromagnetic signal from the first position and second position to the third position (i1);
determining the location of the third position (i1) at or near the measuring device by determining the position which is located at a distance (r1) from the first position and located at a distance (r2) from the second position; and
measuring the refractory lining with the measuring device.

2. The method of measuring the refractory lining of a metallurgical vessel of claim 1 further comprising the steps of:
receiving the first and second signals at a fourth position (i2) at or near the measuring device;
determining the location of the fourth position (i2) at or near the measuring device by determining the position which is located at a distance (r3) from the first position and also located at a distance (r4) from the second position; and
determining the orientation of the measuring device based on the location of the third position relative to the fourth position.

3. A method of measuring the refractory lining of a metallurgical vessel by means of a laser, optical, acoustic, or electromagnetic radiation measuring device comprising the steps of:
transmitting a first signal in the form of undirected electromagnetic radiation from a first position at or near the measuring device;
receiving the first signal at a second and third position in the vicinity of the measuring device;
determining the distance between the first position (i1) and the second position (r1) and between the first position and the third position (r2) based on the time of flight of the electromagnetic signal from the first position to the second position and the third position;
determining the location of the first position (i1) at or near the measuring device by determining the position which is located at a distance (r1) from the third position and also located at a distance (r2) from the second position; and
measuring the refractory lining with the measuring device.

4. The method of measuring the refractory lining of a metallurgical vessel of claim 3 further comprising the step of:
transmitting a second signal at a fourth position (i2) at or near the measuring device; and
determining the location of the fourth position (i2) at or near the measuring device by determining the position which is located at a distance (r3) from the second position and also located at a distance (r4) from the third position; and
determining the orientation of the measuring device based on the location of the first position relative to the fourth position.

5. A method of measuring the refractory lining of a metallurgical vessel by means of a laser, optical, acoustic, or electromagnetic radiation measuring device comprising the steps of:
transmitting a first signal in the form of undirected electromagnetic radiation from a first position in the vicinity of the measuring device;
transmitting a second signal in the form of undirected electromagnetic radiation from a second position in the vicinity of the measuring device;
transmitting a third signal in the form of undirected electromagnetic radiation from a third position in the vicinity of the measuring device;
receiving the first, second and third signals at a fourth position at or near the measuring device;
receiving the first, second and third signals at a fifth position at or near the measuring device;
determining the distance between the first position and the fourth position (r5) and between the second position and the fourth position (r6) and between the third position and the fourth position (r7) based on the time of flight of the electromagnetic signal from the first, second and third positions to the fourth position (i1);
determining the distance between the first position and the fifth position (r8) and between the second position and the fifth position (r9) and between the third position and the fifth position (r10) based on the time of flight of the electromagnetic signal from the first, second and third positions to the fifth position (i2);
determining the location of the fourth position (i1) at or near the measuring device by determining the position which is located at a distance (r5) from the first position and located at a distance (r6) from the second position and located at a distance (r7) from the third position;
determining the location of the fifth position (i2) at or near the measuring device by determining the position which is located at a distance (r8) from the first position and located at a distance (r9) from the second position and located at a distance (r10) from the third position;
determining the orientation of the measuring device based on the location of the fourth position relative to the fifth position; and
measuring the refractory lining with the measuring device.

6. The method of measuring the refractory lining of a metallurgical vessel of claim 5 further comprising the steps of:
receiving the first, second and third signals at a sixth position (i3) at or near the measuring device;
determining the distance between the first position and the sixth position (r11) and between the second position and the sixth position (r12) and between the third position and the sixth position (r13) based on the time of flight of the electromagnetic signal from the first, second and third positions to the sixth position (i3);
determining the location of the sixth position (i3) at or near the measuring device by determining the position which is located at a distance (r11) from the first position and located at a distance (r12) from the second position and located at a distance (r13) from the third position;
determining the orientation of the measuring device based on the location of the fourth position, fifth position and sixth position relative to each other.

7. A method of measuring the refractory lining of a metallurgical vessel by means of a laser, optical, acoustic, or electromagnetic radiation measuring device comprising the steps of: transmitting a first signal in the form of undirected electromagnetic radiation from a first position at or near the measuring device;
transmitting a second signal in the form of undirected electromagnetic radiation from a second position at or near the measuring device;
receiving the first and second signals at a third position in the vicinity of the measuring device;
receiving the first and second signals at a fourth position in the vicinity of the measuring device;
receiving the first and second signals at a fifth position in the vicinity of the measuring device;
determining the distance between the first position and the third position (r5) and between the first position and the fourth position (r6) and between the first position and the fifth position (r7) based on the time of flight of the electromagnetic signal from the first position to the third, fourth and fifth positions;
determining the distance between the second position and the third position (r8) and between the second position and the fourth position (r9) and between the second position and the fifth position (r10) based on the time of flight of the electromagnetic signal from the second position to the third, fourth and fifth positions;
determining the location of the first position (i1) at or near the measuring device by determining the position which is located at a distance (r5) from the third position and located at a distance (r6) from the fourth position and located at a distance (r7) from the fifth position;
determining the location of the second position (i2) at or near the measuring device by determining the position which is located at a distance (r8) from the third position and located at a distance (r9) from the fourth position and located at a distance (r10) from the fifth position;
determining the orientation of the measuring device based on the location of the first position relative to the second position; and
measuring the refractory lining with the measuring device.

8. The method of measuring the refractory lining of a metallurgical vessel of claim 7 further comprising the steps of:
transmitting a third signal in the form of undirected electromagnetic radiation from a sixth position at or near the measuring device;
receiving the third signal at the third, fourth and fifth positions in the vicinity of the measuring device;
determining the distance between the sixth position and the third position (r11) and between the sixth position and the fourth position (r12) and between the sixth position and the fifth position (r13) based on the time of flight of the electromagnetic signal from the sixth position to the third, fourth and fifth positions;
determining the location of the sixth position (i3) at or near the measuring device by determining the position which is located at a distance (r11) from the third position and located at a distance (r12) from the fourth position and located at a distance (r13) from the fifth position; and
determining the orientation of the measuring device based on the location of the fourth position, fifth position and sixth position relative to each other.

9. A system for measuring the refractory lining of a metallurgical vessel comprising a:
measuring device for measuring the contour of the refractory lining;
a first transmitting device for transmitting a first signal in the form of undirected electromagnetic radiation from a first position in the vicinity of the measuring device;
a second transmitting device for transmitting a second signal in the form of undirected electromagnetic radiation from a second position in the vicinity of the measuring device;
a receiving device for receiving the first and second signals at a third position at or near the measuring device;
a data acquisition and processing device for determining the distance between the first position and the third position (r1) and between the second position and the third position (r2) based on the time of flight of the electromagnetic signal from the first position and second position to the third position (i1) and determining the location of the third position (i1) at or near the measuring device by determining the position which is located at a distance (r1) from the first position and located at a distance (r2) from the second position

10. The system for measuring the refractory lining of a metallurgical vessel of claim 9 further comprising:
a device for receiving the first and second signals at a fourth position (i2) at or near the measuring device; and
wherein the data acquisition and processing device determines the location of the fourth position (i2) at or near the measuring device by determining the position which is located at a distance (r3) from the first position and also located at a distance (r4) from the second position; and
determining the orientation of the measuring device based on the location of the third position relative to the fourth position.

11. A system for measuring the refractory lining of a metallurgical vessel comprising a:
measuring device for measuring the contour of the refractory lining;
a first transmitting device for transmitting a first signal in the form of undirected electromagnetic radiation from a first position at or on the measuring device;
a first and second receiving device for receiving the first signal at second and third positions, respectively, in the vicinity of the measuring device;
a data acquisition and processing device for determining the distance between the first position and the second position (r1) and between the first position and the third position (r2) based on the time of flight of the electromagnetic signal from the first position to the second and third position and determining the location of the first position (i1) at or near the measuring device by determining the position which is located at a distance (r1) from the second position and located at a distance (r2) from the third position.

12. The system for measuring the refractory lining of a metallurgical vessel of claim 11 further comprising:
a second transmitting device for transmitting a second signal in the form of undirected electromagnetic radiation from a fourth position at or on the measuring device;
wherein the data acquisition and processing device determines the location of the fourth position (i2) at or near the measuring device by determining the position which is located at a distance (r3) from the second position and also located at a distance (r4) from the third position; and
determining the orientation of the measuring device based on the location of the third position relative to the fourth position.

13. A system for measuring the refractory lining of a metallurgical vessel comprising a:
measuring device for measuring the contour of the refractory lining;
a first transmitting device for transmitting a first signal in the form of undirected electromagnetic radiation from a first position in the vicinity of the measuring device;
a second transmitting device for transmitting a second signal in the form of undirected electromagnetic radiation from a second position in the vicinity of the measuring device;
a third transmitting device for transmitting a third signal in the form of undirected electromagnetic radiation from a third position in the vicinity of the measuring device;
a first receiving device for receiving the first, second and third signals at a fourth position at or near the measuring device;
a second receiving device for receiving the first, second and third signals at a fifth position at or near the measuring device;
a third receiving device for receiving the first, second and third signals at a sixth position at or near the measuring device;
a data acquisition and processing device for:
determining the distance between the first position and the fourth position (r1) and between the second position and the fourth position (r2) and between the third position and the fourth position (r3) based on the time of flight of the electromagnetic signal from the first position, second position and third position to the fourth position (i1) and determining the location of the fourth position (i1) at or near the measuring device by determining the position which is located at a distance (r1) from the first position and located at a distance (r2) from the second position and located at a distance (r3) from the third position;
determining the distance between the first position and the fifth position (r4) and between the second position and the fifth position (r5) and between the third position and the fifth position (r6) based on the time of flight of the electromagnetic signal from the first position, second position and third position to the fifth position (i2) and determining the location of the fifth position (i2) at or near the measuring device by determining the position which is located at a distance (r4) from the first position and located at a distance (r5) from the second position and located at a distance (r6) from the third position;
determining the distance between the first position and the sixth position (r7) and between the second position and the sixth position (r8) and between the third position and the sixth position (r9) based on the time of flight of the electromagnetic signal from the first position, second position and third position to the sixth position (i3) and determining the location of the sixth position (i3) at or near the measuring device by determining the position which is located at a distance (r7) from the first position and located at a distance (r8) from the second position and located at a distance (r9) from the third position; and
determining the orientation of the measuring device based on the location of the fourth, fifth and sixth positions relative to each other.

14. A system for measuring the refractory lining of a metallurgical vessel comprising a:
measuring device for measuring the contour of the refractory lining;
a first transmitting device for transmitting a first signal in the form of undirected electromagnetic radiation from a first position at or near the measuring device;
a second transmitting device for transmitting a second signal in the form of undirected electromagnetic radiation from a second position at or near the measuring device;
a third transmitting device for transmitting a third signal in the form of undirected electromagnetic radiation from a third position at or near the measuring device;
a first receiving device for receiving the first, second and third signals at a fourth position in the vicinity of the measuring device;
a second receiving device for receiving the first, second and third signals at a fifth position in the vicinity of the measuring device;
a third receiving device for receiving the first, second and third signals at a sixth position in the vicinity of the measuring device;
a data acquisition and processing device for:
determining the distance between the fourth position and the first position (r1) and between the fifth position and the first position (r2) and between the sixth position and the fourth position (r3) based on the time of flight of the electromagnetic signals from the first position (i1) to the fourth position, fifth position and the sixth position and determining the location of the first position (i1) at or near the measuring device by determining the position which is located at a distance (r1) from the fourth position and located at a distance (r2) from the fifth position and located at a distance (r3) from the sixth position;
determining the distance between the fourth position and the second position (r4) and between the fifth position and the second position (r5) and between the sixth position and the second position (r6) based on the time of flight of the electromagnetic signals from the second position (i2) to the fourth position, fifth position and sixth position and determining the location of the second position (i2) at or near the measuring device by determining the position which is located at a distance (r4) from the fourth position and located at a distance (r5) from the fifth position and located at a distance (r6) from the sixth position;
determining the distance between the fourth position and the third position (r7) and between the fifth position and the third position (r8) and between the sixth position and the third position (r9) based on the time of flight of the electromagnetic signals from the third position (i3) to the fourth position, fifth position and sixth position and determining the location of the third position (i3) at or near the measuring device by determining the position which is located at a distance (r7) from the first position and located at a distance (r8) from the second position and located at a distance (r9) from the third position; and
determining the orientation of the measuring device based on the location of the first, second and third positions relative to each other.

15. A system for measuring the refractory lining of a metallurgical vessel comprising:
a first transceiver device for transmitting a first signal in the form of undirected electromagnetic radiation from a first position at or near the measuring device;
a second transceiver device for transmitting a second signal in the form of undirected electromagnetic radiation from a second position at or near the measuring device;
a third transceiver device for transmitting a third signal in the form of undirected electromagnetic radiation from a third position at or near the measuring device;
a first transponder device for receiving the first, second and third signals at a fourth position at or near the measuring device and for transmitting a signal in the form of undirected electromagnetic radiation to the first, second and third transceivers;
a second transponder device for receiving the first, second and third signals at a fifth position at or near the measuring device and for transmitting a signal in the form of undirected electromagnetic radiation to the first, second and third transceivers;
a third transponder device for receiving the first, second and third signals at a sixth position at or near the measuring device and for transmitting a signal in the form of undirected electromagnetic radiation to the first, second and third transceivers;
a data acquisition and processing device for:
determining the distance between the first position and the fourth position (r1) and between the first position and the fifth position (r2) and between the first position and the sixth position (r3) based on the time of flight of the electromagnetic signal from the first transceiver device to the first, second and third transponder devices and back to the first transceiver device from the first, second and third transponder devices, respectively;
and determining the location of the fourth position (i1) at or near the measuring device by determining the position (i1) which is located at a distance (r1) from the fourth position and located at a distance (r2) from the fifth position and located at a distance (r3) from the sixth position;
determining the distance between the second position and the fourth position (r4) and between the second position and the fifth position (r5) and between the second position and the sixth position (r6) based on the time of flight of the electromagnetic signal from the second transceiver device to the first, second and third transponder devices and back to the second transceiver device from the first, second and third transponder devices, respectively;
determining the location of the second position (i2) at or near the measuring device by determining the position which is located at a distance (r4) from the fourth position and located at a distance (r5) from the fifth position and located at a distance (r6) from the sixth position;
determining the distance between the third position and the fourth position (r7) and between the third position and the fifth position (r8) and between the third position and the sixth position (r9) based on the time of flight of the electromagnetic signal from the third transceiver device to the first, second and third transponders and back to the third transceiver device from the first, second and third transponder devices, respectively;
determining the location of the third position (i3) at or near the measuring device by determining the position which is located at a distance (r7) from the fourth position and located at a distance (r8) from the fifth position and located at a distance (r9) from the sixth position; and
determining the orientation of the measuring device based on the location of the first, second and third positions relative to each other.

16. A system for measuring the refractory lining of a metallurgical vessel comprising:
measuring device for measuring the contour of the refractory lining;
a first transmitting device for transmitting a first signal in the form of undirected electromagnetic radiation from a first position at or near the measuring device;
a second transmitting device for transmitting a second signal in the form of undirected electromagnetic radiation from a second position at or near the measuring device;
a first receiving device for receiving the first, second and third signals at a third position in the vicinity of the measuring device;
a second receiving device for receiving the first, second and third signals at a fourth position in the vicinity of the measuring device;
a third receiving device for receiving the first, second and third signals at a fifth position in the vicinity of the measuring device;
a data acquisition and processing device for:
determining the distance between the third position and the first position (r1) and between the fourth position and the first position (r2) and between the fifth position and the first position (r3) based on the time of flight of the electromagnetic signals from the first position (i1) to the third position, fourth position, and the fifth position and determining the location of the first position (i1) at or near the measuring device by determining the position which is located at a distance (r1) from the third position and located at a distance (r2) from the fourth position and located at a distance (r3) from the fifth position;
determining the distance between the third position and the second position (r4) and between the fourth position and the second position (r5) and between the fifth position and the second position (r6) based on the time of flight of the electromagnetic signals from the second position (i2) to the third position, fourth position, and fifth position; and
determining the location of the second position (i2) at or near the measuring device by determining the position which is located at a distance (r4) from the third position and located at a distance (r5) from the fourth position and located at a distance (r6) from the fifth position; and
determining the orientation of the measuring device based on the location of the first and second positions relative to each other.

17. A system for measuring the refractory lining of a metallurgical vessel comprising a:
measuring device for measuring the contour of the refractory lining;
a first transmitting device for transmitting a first signal in the form of undirected electromagnetic radiation from a first position in the vicinity of the measuring device;
a second transmitting device for transmitting a second signal in the form of undirected electromagnetic radiation from a second position in the vicinity of the measuring device;
a third transmitting device for transmitting a third signal in the form of undirected electromagnetic radiation from a third position in the vicinity of the measuring device;
a first receiving device for receiving the first, second and third signals at a fourth position at or near the measuring device;
a second receiving device for receiving the first, second and third signals at a fifth position at or near the measuring device;
a data acquisition and processing device for:
determining the distance between the first position and the fourth position (r1) and between the second position and the fourth position (r2) and between the third position and the fourth position (r3) based on the time of flight of the electromagnetic signal from the first position, second position and third position to the fourth position (i1) and determining the location of the fourth position (i1) at or near the measuring device by determining the position which is located at a distance (r1) from the first position and located at a distance (r2) from the second position and located at a distance (r3) from the third position;
determining the distance between the first position and the fifth position (r4) and between the second position and the fifth position (r5) and between the third position and the fifth position (r6) based on the time of flight of the electromagnetic signal from the first position, second position and third position to the fifth position (i2) and determining the location of the fifth position (i2) at or near the measuring device by determining the position which is located at a distance (r4) from the first position and located at a distance (r5) from the second position and located at a distance (r6) from the third position; and
determining the orientation of the measuring device based on the location of the fourth and fifth positions relative to each other.
